(19) United States
(12) Patent Application Publication
(10) Pub. No.: US 2018/0133960 A1
(43) Pub. Date: May 17, 2018

(54) APPARATUS FOR ADDITIVE MANUFACTURING OF THREE-DIMENSIONAL OBJECTS

(71) Applicant: CL SCHUTZRECHTSVERWALTUNGS GMBH, Lichtenfels (DE)

(72) Inventors: Daniel Winiarski, Bad Staffelstein (DE); Jens Stammberger, Rodental (DE)

(73) Assignee: CL SCHUTZRECHTSVERWALTUNGS GMBH, Lichtenfels (DE)

(21) Appl. No.: 15/812,564

(22) Filed: Nov. 14, 2017

(30) Foreign Application Priority Data
Nov. 14, 2016 (DE) 102016121781.6

(51) Int. Cl. B29C 64/25; B29C 64/153; B22F 3/105; B33Y 30/00; B33Y 10/00

(52) U.S. Cl. CPC B29C 64/25; B29C 64/153; B29C 64/268; B33Y 30/00; B33Y 10/00; B22F 3/1055

(57) ABSTRACT

An apparatus (1) for additive manufacturing of three-dimensional objects (2) by successive, selective layer-by-layer exposure and thus solidification of construction material layers of a construction material (3) that can be solidified by means of an energy beam (6), comprising an outer frame construction (4) comprising one or more frame construction elements, and a process block (8) that can be arranged or that is arranged as a separate construction unit within the outer frame construction (4), wherein on and/or in the process block (8) several functional components of the apparatus (1) are arranged or formed in a defined spatial arrangement and/or orientation, wherein the process block (8) forms the reference system for the defined spatial arrangement of the functional components of the apparatus (1) arranged or formed on and/or in said process block.

### DESCRIPTION

The invention relates to an apparatus for additive manufacturing of three-dimensional objects by successive, selective layer-by-layer exposure and thus solidification of construction material layers of a construction material that can be solidified by a generated energy beam, comprising an outer frame construction comprising one or more frame construction elements.

Respective apparatuses for additive manufacturing of three-dimensional objects, e.g. in the form of apparatuses for performing selective laser sintering methods or selective laser melting methods, are per se known. Respective apparatuses comprise a frame construction comprising one or more frame construction elements. The functional components of the apparatus, such as an exposure device, are typically arranged on the outer frame construction or the frame construction elements associated with that.

Until now, it is common that the outer frame construction or the frame construction elements associated with that form a reference system for a defined spatial arrangement and/or orientation of the functional components of the apparatus. As a reference system for a defined spatial arrangement and/or orientation of the functional components, in structural terms the outer frame construction needs to have comparatively narrow tolerances. Thus, the outer frame construction is both in geometric-structural terms and in manufacturing terms a comparatively complex assembly of the apparatus.

The invention is based on the object of providing, in contrast to the above, an improved apparatus for manufacturing of three-dimensional objects.

The object is solved by an apparatus for additive manufacturing of three-dimensional objects according to claim 1. The dependent claims relate to possible embodiments of the apparatus.

The apparatus (“apparatus”) described herein is provided for additive manufacturing of objects, i.e., for example, technical components or technical component groups, by successive, selective layer-by-layer exposure and thus successive, selective layer-by-layer solidification of construction material layers of a construction material that can be solidified. The construction material can especially be a particulate or powdered metal material, plastic material, and/or ceramic material. The selective solidification of respective construction material layers to be selectively solidified is carried out based on object-related construction data. Respective construction data describe the geometric structural design of the respective object to be additively manufactured and can, for example, include “sliced” CAD data of the object to be additively manufactured. The apparatus can be formed as an SLM apparatus, i.e. as an apparatus for performing selective laser melting methods (SLM methods), or as an SLS apparatus, i.e. as an apparatus for performing selective laser sintering methods (SLS methods).

The apparatus comprises the functional components typically required for performing additive construction processes. This especially involves a coating device provided for forming construction material layers to be selectively solidified (in the construction plane of the apparatus) and an exposure device provided for the selective exposure of construction material layers to be selectively solidified (in the construction plane of the apparatus). The coating device typically comprises several components, i.e., for example, a coating element comprising an, especially blade-shaped, coating tool, and a guiding device for guiding the coating element along a defined trajectory. The exposure device typically also comprises several components, i.e., for example, a beam generation device for generating an energy or laser beam, a beam deflection device for deflecting an energy or laser beam generated by the beam generation device to a section to be exposed, of a construction material layer to be selectively solidified, and various optical elements, such as filter elements, objective elements, lens elements, etc.

The apparatus comprises an outer frame construction (“frame construction”) comprising one or more frame construction elements. The frame construction can form a (closed) housing or covering construction of the apparatus. The frame construction thus (significantly) defines the outer design of the apparatus.

In addition to the frame construction, the apparatus comprises a process block that can be arranged or is arranged within the frame construction. On and/or in the process block several functional components of the apparatus (“functional components”) are arranged or formed. The process block thus comprises one or more attachment interfaces, which are provided for attaching at least one functional component to the process block. Respective attachment interfaces can enable a form-locked and/or force-locked and/or substance attachment of a functional component to the process block. An attachment interface enabling a force-lock attachment of the functional component to the process block can, e.g., be or comprise a bore, especially a threaded hole, which can be penetrated by a screw element. Eligible form-locked attachment types are, e.g., clip attachments or locking attachments; eligible substance attachments are, e.g., adhesive joints, soldered joints, or welding joints. Apart from possible user or operating interfaces, such as an operating device communicating with a control device of the apparatus controlling the operation of the functional components for performing additive construction processes, e.g. in the form of a touch panel, and/or connecting elements, e.g. for connecting an external (electric) energy supply for certain functional components, no functional components need to be arranged or formed on the frame construction.

The process block, along with the functional components arranged or formed on and/or in it, constitutes (regarding the frame construction) a separate, i.e., movable especially independently from the frame construction, construction unit; the process block thus forms no component of the frame construction. The process block can especially be arranged within the frame construction such that it or the functional components arranged or formed on and/or in it are in no contact with the frame construction; consequently, it is conceivable that between the process block or the functional components arranged or formed on and/or in it, there is no mechanical contact. The process block or the functional components arranged or formed on and/or in it can thus be mechanically decoupled from the frame construction. Possible forces, vibrations, etc. brought into the frame construction cannot be transferred to the process block or the functional components arranged or formed on and/or in it, which is positively affecting the operation thereof.

The functional components arranged or formed on and/or in the process block are arranged on and/or in it in a positioning that can exactly be defined or is defined, i.e. arrangement and/or orientation. The process block forms the reference system for the defined spatial arrangement of the functional components arranged or formed on and/or in it. The process block has typically defined process block axes, which can form an, e.g. Cartesian, coordinate system of the process block. It is not required that the frame construction in structural terms has comparatively narrow dimensional tolerances (“tolerances”). Thus, the frame construction does not need to be both in geometric-structural terms and in manufacturing terms a comparatively complex assembly of the apparatus. The process block can rather be a comparatively simply built construction unit in geometric-structural terms, such that it is comparatively less complicated to manufacture it with narrow tolerances, which is required for using it as reference system for an accurate positioning of the functional components. Specifically, the process block can, e.g., be a milled part.

The process block as well as the functional components arranged or formed on and/or in it can form an assembly that can be preconfigured or is preconfigured and separately manageable. Thus it is possible to equip or preconfigure the process block with certain functional components and in such a way form an assembly that is preconfigured, separately manageable, i.e. especially transportable. In such a way, e.g. assembly, repair or service tasks of the apparatus can be simplified.

The functional components can directly or indirectly, i.e., by interconnecting at least one assembly component, be arranged on and/or in the process block. In case of an indirect attachment of functional components, the functional components arranged on the process block can be attached to the process block by an assembly component that can be attached or is attached to the process block. The functional components can be attached in a fixed and stable arrangement and orientation to the assembly component; the assembly component can be attached in a fixed and stable arrangement and orientation to the process block. The assembly component can, e.g., be formed as an assembly block or assembly bracket. The assembly component has narrow tolerances such that functional components attached by it are accurately positioned.

At this point it must be mentioned that until now, usually complex provisions on the apparatus side have been made, especially by the provision of suitable setting or adjustment devices, in order to be able to later adjust or change the positioning of respective functional components attached to the frame construction, i.e., after the actual assembly thereof in terms of a required positioning accuracy. Such setting or adjustment devices provided to later adjust or change the positioning of respective functional components attached to the frame construction can entirely be omitted in the apparatus described herein. The required accurate positioning of respective functional components is guaranteed by the arrangement or orientation thereof on and/or in the process block. As mentioned, the process block is typically provided with narrow tolerances, enabling an accurate positioning of respective functional components.

A respective assembly component can comprise at least one first attachment interface provided for attaching a functional component in a fixed and stable positioning to the assembly component. A first attachment interface can enable a form-locked and/or force-locked and/or substance attachment of the functional component to the assembly component. A respective assembly component can comprise at least one second attachment interface provided for attaching the assembly component in a fixed and stable positioning to the process block. A second attachment interface can enable a form-locked and/or force-locked and/or substance attachment of the assembly component to the process block. An attachment interface enabling a force-locked attachment of the functional component to the assembly component can, e.g., be or comprise a bore that can be penetrated by a screw element; also, an attachment interface enabling a force-locked attachment of the assembly component to the process block can, e.g., be or comprise a bore, especially a threaded bore, that can be penetrated by a screw element. Form-locked or force-locked attachment types have been mentioned above. Although the positioning of the functional component(s) on the assembly component or the positioning of the assembly component on the process block is fixed and stable, it can be detachable (in a damage-free and non-destructive manner).

The process block can comprise a process block base body. The process block base body can limit the process chamber of the apparatus being a functional component. The process chamber of the apparatus can thus be formed by a respective interior space in the process block (base body).

On the process block base body at least one component of an exposure device forming a functional component, provided for the selective exposure of construction material layers to be selectively solidified, can precisely be arranged or is precisely arranged. The at least one component of the exposure device can, e.g., be arranged on or attached to an exposed outer surface of the process block base body. As component of the exposure device, e.g. an energy beam generation device and/or a beam deflection device and/or at least one optical element, especially a filter element, an objective element, or a lens element, of the exposure device can be arranged or is arranged on the process block base body. Respective components of the exposure device can also be attached to the process block base body by at least one respective assembly component.

On the process block base body at least one component of an exposure device forming a functional component, provided for forming construction material layers to be selectively solidified in a construction plane of the apparatus, can also precisely be arranged or is precisely arranged. The at least one component of the exposure device can, e.g., be arranged on or attached to an inner surface of the process block base body limiting the process chamber. As component of the coating device, a guiding device for a coating element having an, especially blade-shaped, coating tool, and/or a coating element having an, especially blade-shaped, coating tool can be arranged or is arranged on the process block base body. Respective components of the coating device can also be attached to the process block base body by a respective assembly component.

In addition, on the process block base body at least one component of a detection device forming a functional component of the apparatus, provided for (optical) detection of at least one detection variable especially regarding a process-relevant (physical) parameter, such as atmosphere, pressure, temperature, melting pool geometry, etc., can precisely be arranged or is precisely arranged. The at least one component of the detection device can also, e.g., be arranged on or attached to an inner surface of the process block base body limiting the process chamber. As component of the detection device, e.g. an optical or thermal detection element, especially an optical or thermal camera, can be arranged or is arranged on the process block base body. Respective components of the detection device can also be attached to the process block base body by a respective assembly component.

On the process block base body a powder module limiting a powder reception room can further precisely be arranged or is precisely arranged. The powder module can form a bottom end of the process block base body. The powder module can especially be a construction module in the powder reception room (construction room) of which the actual additive manufacturing of three-dimensional objects is carried out.

In order to realize an oscillation decoupling of the process block from the frame construction, between the process block and the frame construction at least one attenuation or oscillation decoupling element can be arranged or formed. For a sufficient oscillation decoupling, several attenuation or oscillation decoupling elements are typically to be connected between the process block and the frame construction. A respective attenuation or oscillation decoupling element can, e.g., be formed as elastic or viscoelastic element, especially as an elastic spring element or viscoelastic elastomer element.

A guiding device can be assigned to the process block. The guiding device can be provided to move the process block into an operating position, in which the process block is arranged within the frame construction, and into a non-operating position, in which the process block is arranged outside the frame construction, and vice versa. It is also conceivable that the guiding device is provided to move, i.e. possibly also to turn, the process block into several defined positions within the frame construction. A respective guiding device can comprise suitable, e.g. rail-like or rail-shaped, guiding elements, along which the process block can be moved, e.g. between the operating position and the non-operating position. By providing a respective guiding device, e.g. assembly, repair, or service tasks of the apparatus can be simplified.

The process block can at least comprise a connecting element, e.g. for connecting an external (electric) energy or inert gas supply for the functional components arranged or formed on or in the process block. The process block can thus form a (widely) self-sustaining functional unit.

The invention is explained in more detail by means of exemplary embodiments in the figures of the drawings. In which:

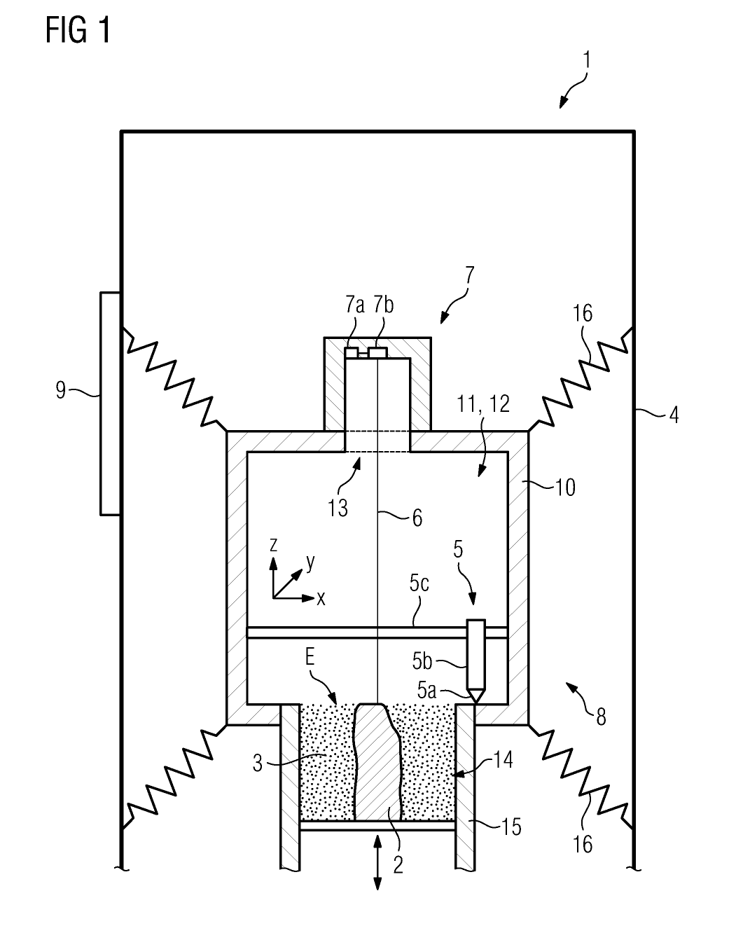

FIG. 1 shows a schematic diagram of an apparatus according to an exemplary embodiment; and

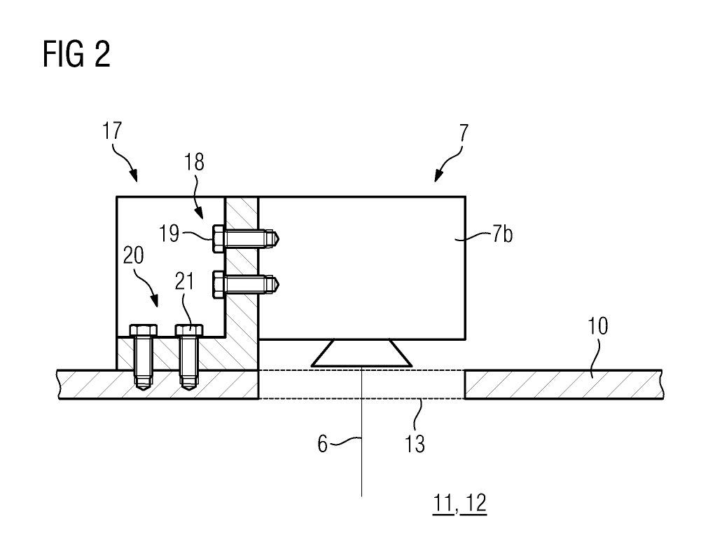

FIG. 2 shows a schematic diagram of an assembly state of a functional component of the apparatus according to an exemplary embodiment.

FIG. 1 shows a schematic diagram of an apparatus 1 according to an exemplary embodiment. FIG. 1 only shows the detail of the apparatus 1 that is relevant for the discussion of the principle described in the following in a sectional view.

The apparatus 1 serves the additive manufacturing of three-dimensional objects 2, i.e. especially technical components or technical component groups, by successive, selective layer-by-layer exposure and thus successive, selective layer-by-layer solidification of construction material layers of a construction material 3, i.e., for example, a metal powder, that can be solidified by means of a laser beam 6. The selective solidification of respective construction material layers to be solidified is carried out based on object-related construction data. Respective construction data describe the geometric or geometric structural design of the respective object 2 to be additively manufactured and can, for example, include “sliced” CAD data of the object 2 to be manufactured. The apparatus 1 can be formed as a Laser-CUSING® apparatus, i.e. as an apparatus for performing selective laser melting methods.

The apparatus 1 comprises an outer frame construction 4 comprising one or more frame construction elements (not denoted). The frame construction 4 forms a (closed) housing or covering construction of the apparatus 1. The outer design of the apparatus 1 is thus (significantly) defined by the frame construction.

The apparatus 1 comprises the functional components required for performing additive construction processes. This involves a coating device 5 provided for forming construction material layers to be selectively solidified (in the construction plane E of the apparatus 1) and an exposure device 7 provided for the selective exposure of construction material layers to be selectively solidified (in the construction plane E of the apparatus 1). The coating device 5 typically comprises several components, i.e., for example, a coating element 5b comprising an, especially blade-shaped, coating tool 5a, and a guiding device 5c for guiding the coating element 5b along a defined trajectory. The exposure device 7 also comprises several components, namely a beam generation device 7a for generating a laser beam 6, a beam deflection device 7b for deflecting the laser beam 6 generated by the beam generation device 7a to a section to be exposed of a construction material layer to be selectively solidified, and various optical elements (not shown), such as filter elements, objective elements, lens elements, etc., which are typically arranged between the beam generation device 7a and the beam deflection device 7b.

In addition to the frame construction 4, the apparatus 1 comprises a process block 8 arranged within the frame construction 4. Evidently, the functional components of the apparatus 1 mentioned are arranged on and/or in the process block 8. The process block 8 thus comprises one or more attachment interfaces (not denoted in more detail), which are provided for attaching at least one functional component to the process block 8. Respective attachment interfaces can enable a form-locked and/or force-locked and/or substance attachment of a functional component to the process block 8. An attachment interface enabling a force-locked attachment of the functional component to the process block 8 can, e.g., be or comprise a bore, especially a threaded hole, which can be penetrated by a screw element. Eligible form-locked attachment types are, e.g., clip attachments or locking attachments; eligible substance attachments are, e.g., adhesive joints, soldered joints, or welding joints. Apart from possible user or operating interfaces (not shown), such as an operating device 9 communicating with a control device (not shown) controlling the operation of the functional components for performing additive construction processes, e.g. in the form of a touch panel, and/or connecting elements (not shown), e.g. for connecting an external (electric) energy supply for certain functional components, no functional components need to be arranged or formed on the frame construction 4.

The process block 8 along with the functional components arranged or formed on and/or in it constitutes (regarding the frame construction 4) a separate, i.e., movable especially independently of the frame construction 4, construction unit; the process block 8 thus forms no component of the frame construction 4. The process block 8 is especially arranged within the frame construction 4 such that it or the functional components arranged or formed on and/or in it are in no contact with the frame construction 4; between the process block 8 or the functional components arranged or formed on and/or in it and the frame construction 4 there is no mechanical contact. The process block or the functional components arranged or formed on and/or in it are thus mechanically decoupled from the frame construction 4. Possible forces, vibrations, etc. brought into the frame construction 4 cannot be transferred to the process block 8 or the functional components arranged or formed on and/or in it, which is positively affecting the operation thereof.

The functional components arranged or formed on and/or in the process block 8 are arranged on and/or in it in a positioning that can exactly be defined or is defined, i.e., arrangement and/or orientation. The process block 8 forms the reference system for the defined spatial arrangement of the functional components arranged or formed on and/or in it. For this purpose, the process block 8 has defined process block axes (x-, y- and z-axes) forming an, e.g. Cartesian, coordinate system of the process block 8. In geometric-structural terms, the process block 8 is a comparatively simply built constructional unit—specifically the process block 8 can, e.g., be a milling part—which can be manufactured with narrow tolerances with comparatively low effort. Respective narrow tolerances are required to use the process block 8 as reference system for an accurate positioning of the functional components.

The process block 8 comprises a process block base body 10. In the exemplary embodiment, the process block base body 10 comprises one or more walls or wall portions (not denoted in more detail) partially (rect)angular to each other, limiting an interior space 11. The interior space 11 of the process block base body 10 forms the (inertable) process chamber 12 of the apparatus 1 being a functional component. The process chamber 12 of the apparatus 1 is thus formed in the process block 8.

On the process block base body 10 the components, i.e. the laser beam generation device 7a, the beam deflection device 7b, the optical elements, of the exposure device 7 forming a functional component are further precisely arranged. In the exemplary embodiment, the components of the exposure device 7 are arranged or formed on an exposed outer surface of the process block base body 10 formed by an upper wall of the process block base body 10 provided with an opening 13 for the laser beam 6.

On the process block base body 10 the components, i.e. the coating tool 5a, coating element 5b, the guiding device 5c, of the coating device 5 forming a functional component are further also precisely arranged. In the exemplary embodiment, the components of the coating device 5 are arranged or formed on an inner surface of the process block base body 10 formed by a wall limiting the interior space 11 or the process chamber 12.

In addition, on the process block base body 10 (also) components (not shown) of a detection device forming a functional component of the apparatus 1, provided for (optical) detection of at least one detection variable especially regarding a process-relevant (physical) parameter, such as atmosphere, pressure, temperature, melting pool geometry, etc., can precisely be arranged or are precisely arranged. The components of the exposure device can, e.g., also be arranged on or attached to a respective inner surface of the process block base body 10. As component of the detection device, e.g. an optical or thermal detection element, especially an optical or thermal camera, can be arranged or is arranged on the process block base body 10.

On the process block base body 10 a powder module 15 limiting a powder reception room 14 is further precisely arranged. The powder module 15 forms the bottom end of the process block base body 10. The powder module 15 is a construction module in the powder reception room 14 (construction room) of which the actual additive manufacturing of three-dimensional objects 2 is carried out.

The process block 8 as well as the functional components arranged or formed on and/or in it can form an assembly that can be preconfigured or is preconfigured and separately manageable. Thus it is possible to equip or preconfigure the process block 8 with certain functional components and thus form an assembly that is preconfigured, separately manageable, i.e. especially transportable.

In order to realize an oscillation decoupling of the process block 8 from the frame construction 4, in the exemplary embodiment there are attenuation or oscillation decoupling elements 16 arranged or formed between the process block 8 and the frame construction 4. A respective attenuation or oscillation decoupling element 16 can, e.g., be formed as elastic or viscoelastic element, especially as an elastic spring element or viscoelastic elastomer element. Respective attenuation or oscillation decoupling elements 16 are optionally present.

The process block 8 can be assigned with a guiding device (not shown). The guiding device is, e.g., provided to move the process block 8 into an operating position, in which the process block 8 is arranged within the frame construction 4, and into a non-operating position, in which the process block 8 is arranged outside the frame construction 4, and vice versa. It is also conceivable that the guiding device is provided to move, i.e. possibly also to turn, the process block 8 in several defined positions within the frame construction 4. A respective guiding device can comprise suitable, e.g. rail-like or rail-shaped, guiding elements, along which the process block 8 can be moved between different positions, e.g. between the operating position and the non-operating position.

The process block 8 can at least comprise a connecting element (not shown), e.g. for connecting an external (electric) energy or inert gas supply for the functional components arranged or formed on or in the process block 8. Respective connecting elements can, e.g., be arranged or formed on the process block base body 10.

Basically, the functional components can directly or indirectly, i.e. by interconnecting at least one assembly component 17 (cf. FIG. 2), be arranged on and/or in the process block 8.

FIG. 2 shows a schematic diagram of an assembly state of a functional component of the apparatus 1 according to an exemplary embodiment.

In FIG. 2, the case of an indirect attachment of a functional component is shown; here, a beam deflection device 7a is exemplified as a component of the exposure device 7. The functional component is attached to the process block 8 via an assembly component 17 attached to the process block 8 or the process block base body 10. The functional component is attached in a fixed and stable arrangement and orientation to the assembly component 17; the assembly component 17 is attached in a fixed and stable arrangement and orientation to the process block 8. The assembly component 17, which can, e.g., be formed as an assembly block or assembly bracket, has narrow tolerances such that the functional component attached to the process block 8 via said block or bracket is accurately positioned.

The assembly component 17 comprises at least one first attachment interface 18 provided for attaching the functional component in a fixed and stable positioning to the assembly component 17. In the exemplary embodiment the first attachment interface 18 enables a force-locked attachment of the functional component to the assembly component 17. Specifically, the first attachment interface 18 comprises several bores (not shown), especially threaded bores, which can be penetrated by a screw element 19.

The assembly component 17 further comprises at least one second attachment interface 20 provided for attaching the assembly component 17 in a fixed and stable positioning to the process block 8. In the exemplary embodiment, the second attachment interface 20 also enables a force-locked attachment of the functional component to the process block 8. 4. Specifically, the second attachment interface 20 also comprises several bores (not shown), especially threaded bores, which can be penetrated by a screw element 21.

Although the positioning of the functional component on the assembly component 17 or the positioning of the assembly component 17 on the process block 8 is fixed and stable, it can, as seen by means of the screw attachments, be detachable (in a damage-free and non-destructive manner).

1. An apparatus (1) for additive manufacturing of three-dimensional objects (2) by successive, selective layer-by-layer exposure and thus solidification of construction material layers of a construction material (3) that can be solidified by means of an energy beam (6), comprising an outer frame construction (4) comprising one or more frame construction elements, characterized by a process block (8) that can be arranged or that is arranged as a separate construction unit within the outer frame construction (4), wherein on and/or in the process block (8) several functional components of the apparatus (1) are arranged or formed in a defined spatial arrangement and/or orientation, wherein the process block (8) forms the reference system for the defined spatial arrangement of the functional components of the apparatus (1) arranged or formed on and/or in said process block.

2. The apparatus according to claim 1, characterized in that the process block (8) arranged within the outer frame construction (4) and the functional components of the apparatus (1) arranged or formed on or in said process block are in no contact with the outer frame construction (4).

3. The apparatus according to claim 1, characterized in that the process block (8) and the functional components of the apparatus (1) arranged or formed on or in said process block form an assembly that can be preconfigured or is preconfigured and separately manageable.

4. The apparatus according to claim 1, characterized in that the functional components of the apparatus (1) arranged on the process block (8) are attached to the process block (8) via an assembly component (17) that can be attached or is attached to the process block (8), wherein the functional components are attached to the assembly component (17) in a fixed and stable arrangement and orientation, and the assembly component (17) is attached to the process block (8) in a fixed and stable arrangement and orientation.

5. The apparatus according to claim 1, characterized in that the process block (8) comprises a process block base body (10), wherein the process block base body (10) limits a process chamber (12) of the apparatus (1).

6. The apparatus according to claim 1, characterized in that the process block (8) comprises a process block base body (10), wherein at least one component of an exposure device (7) forming a functional component of the apparatus (1), which is provided for the selective exposure of construction material layers to be selectively solidified, can precisely be arranged or is precisely arranged on the process block base body (10).

7. The apparatus according to claim 6, characterized in that as component of the exposure device (7) an energy beam generation device (7b) and/or a beam deflection device (7a) and/or at least one optical element, especially a filter element, an objective element or a lens element, of the exposure device (7) can be arranged or is arranged on the process block base body (10).

8. The apparatus according to claim 1, characterized in that the process block (8) comprises a process block base body (10), wherein at least one component of an exposure device (5) forming a functional component of the apparatus (1), which is provided for forming construction material layers to be selectively solidified in a construction plane (E) of the apparatus (1), can be precisely arranged or is precisely arranged to the process block base body (10).

9. The apparatus according to claim 8, characterized in that as component of the coating device (5) a guiding device (5c) for a coating element (5b) having an, especially blade-shaped, coating tool (5a), and/or a coating element (5b) having an, especially blade-shaped, coating tool (5a) can be arranged or is arranged on the process block base body (10).

10. The apparatus according to claim 1, characterized in that the process block (8) comprises a process block base body (10), wherein at least one component of a detection device forming a functional component of the apparatus (1), which is provided for (optical) detection of at least one detection variable, especially regarding a process-relevant parameter, can precisely be arranged or is precisely arranged on the process block base body (10).

11. The apparatus according to claim 10, characterized in that as component of the detection device an optical or thermal detection element, especially a camera, can be arranged or is arranged.

12. The apparatus according to claim 1, characterized in that the process block (8) comprises a process block base body (10), wherein a powder module (15) limiting a powder reception room (14) can precisely be arranged or is precisely arranged on the process block base body (10).

13. The apparatus according to claim 1, characterized in that between the process block (8) and the outer frame construction (4) at least one oscillation decoupling element (16) for oscillation decoupling the process block (8) from the outer frame construction (4) is arranged or formed.

14. The apparatus according to claim 1, characterized by a guiding device assigned to the process block (8), wherein the guiding device is provided to move the process block (8) into an operating position, in which the process block (8) is arranged within the outer frame construction (4), and into a non-operating position, in which the process block (8) is arranged outside the outer frame construction (4).

15. The apparatus according to claim 1, characterized in that the process block (8) comprises at least one connecting element for connecting an external energy supply for the functional components of the apparatus (1) arranged or formed on or in the process block (8).
